(19) United States
(12) Patent Application Publication
(10) Pub. No.: US 2017/0100789 A1
(43) Pub. Date: Apr. 13, 2017

(54) TUBE CUTTING DEVICE HAVING CONICAL FITTING MEMBER TO CUT TUBE OF WASTE STEAM GENERATOR

(71) Applicant: DOOSAN HEAVY INDUSTRIES & CONSTRUCTION CO., LTD., Changwon-si (KR)

(72) Inventors: Kwangsoo PARK, Changwon-si (KR); Seonho LEE, Changwon-si (KR); Kwangyong PARK, Changwon-si (KR)

(73) Assignee: DOOSAN HEAVY INDUSTRIES & CONSTRUCTION CO., LTD., Changwon-si (KR)

(21) Appl. No.: 15/288,460

(22) Filed: Oct. 7, 2016

(30) Foreign Application Priority Data
Oct. 8, 2015 (KR) 10-2015-0141792

(51) Int. Cl. B23D 21/14

(52) U.S. Cl. CPC B23D 21/145

(57) ABSTRACT

A tube cutting device for cutting a tube of a waste steam generator including: a body configured to transmit power; a tube-shaped rotary body provided on a side surface of the body and having a horizontal rotary shaft configured to rotate with the power supplied from the body; a plurality of clamps provided along an outer peripheral surface of a first end portion of the rotary body and configured to fix the rotary body to the tube to be cut; a saw provided on a second end portion opposite to the first side end portion of the rotary body and configured to rotate together with the rotary body to cut the tube; and a fitting member configured to be inserted into a hollow portion formed on a center portion of the saw.

### CROSS-REFERENCE TO RELATED APPLICATION

This application claims benefit of priority to Korean Patent Application No. 10-2015-0141792 filed on Oct. 8, 2015 in the Korean Intellectual Property Office, the disclosure of which is incorporated herein by reference in its entirety.

### BACKGROUND

1. Field

Apparatuses consistent with exemplary embodiments relate to a tube cutting device for cutting a tube of a waste steam generator, and more particularly, to a tube cutting device that is provided with a saw mounted at an interior of a small-sized tube attached to the steam generator to cut the small-sized tube at the time when the steam generator is removed from a nuclear power plant.

2. Background of the Related Art

In the related art, a nuclear power plant is classified into a nuclear steam supply system around a nuclear reactor, a generator system like a turbine to run a generator with the steam received thereto, and other accessory facilities.

In this case, the nuclear steam supply system includes a pressurizer, a steam generator, a main coolant pump, and the nuclear reactor in which the fission of nuclear fuels is conducted.

Among them, the steam generator is configured wherein a high temperature and high pressure primary coolant, in which radioactive substances generated from the nuclear reactor are contained, flows along the inner peripheral surface of a steam generator tube, so that the cool feed water on the outside of the steam generator tube becomes heated to generate steam therefrom and to supply the generated steam to the turbine.

The steam generator tube is made of Ni-based alloy 600 or 690 having excellent corrosion resistance at a high temperature and a high pressure.

On the other hand, the primary cooling water circulating the interior of the steam generator is contaminated by heating and radioactivity, while passing through the nuclear reactor, and if the steam generator tube is broken by the high temperature and high pressure water having the radioactivity through the pressurization of the pressurizer, secondary cooling water is contaminated, thereby causing radioactivity leakage.

Accordingly, the steam generator in the nuclear power plant has a very important role as a primary protection facility through which the radioactive substances are isolated therefrom.

If the steam generator is removed or partially repaired by aging, it should be careful about the contamination by the radioactive substances.

Accordingly, the removing or repairing work has to be conducted not by a worker, but by a machine in a wired or wireless manner.

So as to disassemble the waste steam generator, while preventing the radioactive contamination substances from being diffused, the waste steam generator should be first divided into non-contamination structures and contamination structures.

The waste steam generator has complicated structures and is also contaminated by the radioactivity, and accordingly, it has to be disassembled, while giving any damage to the structures

So as to disassemble the internal structures of the waste steam generator, first, a shell of the waste steam generator has to cut.

In case of cutting the shell in a conventional practice, the steam generator is first separated from the nuclear power plant, moves to a closed work place located at the outside of the nuclear power plant, and cuts the shell by means of thermal treatment. In the conventional shell cutting process, however, the steam generator has to be inconveniently separated from the nuclear power plant, and in this case, dust and aerosol as secondary contamination substances are generated, thereby additionally needing the treatment for the secondary contamination substances.

It is hard to cut the steam generator tube from the outer peripheral surface thereof according to the structural characteristics of the steam generator, and accordingly, there is a need for the development of a new tube cutting device capable of cutting the tube of the waste steam generator in the direction of the outside of the tube from the inside of the tube.

### SUMMARY

Accordingly, the present disclosure has been made in view of the above-mentioned problems occurring in the prior art, and it is an object of the present exemplary embodiments to provide a tube cutting device having a saw and a conical fitting member to cut a tube of a waste steam generator, wherein the tube cutting device is first conveyed to a place in which the waste steam generator is installed, is insertedly put into the tube of the waste steam generator, and then cuts the tube in the direction of the outside of the tube from the inside of the tube.

It is another object of the exemplary embodiments to provide a tube cutting device for cutting a tube of a waste steam generator that is capable of conducting the cutting, while the waste steam generator is not being separated from a nuclear power plant, unlike the conventional practice, generating no dust and aerosol as secondary contamination substances therefrom, and safely protecting a worker from radioactive contamination substances not through labor force, but through mechanical work.

To accomplish the above-mentioned objects, according to an aspect of an exemplary embodiment, there is provided a tube cutting device for cutting a tube of a waste steam generator, the tube cutting device including: a body fixedly located to transmit power therefrom; a tube-shaped rotary body located on one side surface of the body and having a horizontal rotary shaft in such a manner as to rotate in a given direction with the power supplied from the body; a plurality of clamps located along the outer peripheral surface of the body side end portion of the rotary body to fix the rotary body to the tube to be cut; and a saw located on the opposite end portion to the body side end portion of the rotary body in such a manner as to rotate together with the rotary body to cut the tube.

According to an exemplary embodiment, the body includes a ball screw adapted to linearly drive the rotary body on the horizontal axis thereof in the interior of the tube to be cut.

According to an exemplary embodiment, the body includes any one of a clamp motor adapted to drive the plurality of clamps, the clamp motor having a rotor, a stator, a ball bearing and a shaft and a clamp cylinder adapted to drive the plurality of clamps, the clamp cylinder having a hydraulic cylinder.

According to an exemplary embodiment, the body includes a plurality of spur gears engaged with the clamp motor to drive the plurality of clamps.

According to an exemplary embodiment, the saw is entirely formed in a doughnut shape and includes the hollow portion formed on the center thereof and a plurality of saw blades segmented with a given size and shape.

According to an exemplary embodiment, the body includes a saw blade driving motor adapted to move the plurality of segmented saw blades to the inner peripheral wall of the tube.

According to an exemplary embodiment, the tube cutting device further includes a controller adapted to wiredly or wirelessly control the driving of the rotary body, the clamps and the saw.

According to an aspect of another exemplary embodiment, there is provided a tube cutting device for cutting a tube of a waste steam generator, the tube cutting device including: a body configured to transmit power; a tube-shaped rotary body provided on a side surface of the body and having a horizontal rotary shaft configured to rotate with the power supplied from the body; a plurality of clamps provided along an outer peripheral surface of a first end portion of the rotary body and configured to fix the rotary body to the tube to be cut; a saw provided on a second end portion opposite to the first side end portion of the rotary body and configured to rotate together with the rotary body to cut the tube; and a fitting member configured to be inserted into a hollow portion formed on a center portion of the saw.

The body may include a ball screw configured to linearly drive the rotary body on a horizontal axis of the rotary body.

The body may include a ball screw configured to drive the fitting member forwardly and backwardly along a horizontal line toward and from the hollow portion of the saw.

The fitting member may have a conical shape and is disposed on an opposite side to a side of the saw facing the body, and a portion of the fitting member may be configured to be inserted into the hollow portion formed on the center portion of the saw.

The body may include a clamp motor configured to drive the plurality of clamps, and the clamp motor may include: a motor rotary body; a stator; a ball bearing; and a motor shaft.

The body may include a clamp cylinder configured to drive the plurality of clamps, and the clamp cylinder may include a hydraulic cylinder.

The body may further include a plurality of spur gears engaged with the clamp motor and configured to drive the plurality of clamps.

The saw may be formed in a doughnut shape and includes: the hollow portion formed on the center portion thereof; and a plurality of saw blades forming the saw.

The body may include a saw blade driving motor configured to move the plurality of saw blades toward an inner peripheral wall of the tube.

The tube cutting device may further include a controller configured to wiredly or wirelessly control the driving of the rotary body, the plurality of clamps and the saw. To accomplish the above-mentioned objects, according to an aspect of an exemplary embodiment, there is provided a tube cutting method for cutting a tube of a waste steam generator, the tube cutting method including: the clamping step of fixing a tube-shaped rotary body in such a manner as to be separated from a tube to be cut by a given distance by means of a plurality of clamps disposed along the outer peripheral surface of the body side end portion of the rotary body; the rotary body forward/backward driving step of linearly driving the rotary body on the horizontal axis in the interior of the tube to be cut by means of a ball screw; and the cutting step of moving a plurality of saw blades of a saw to the inner peripheral wall of the tube to cut the tube.

According to an exemplary embodiment, the clamping step includes any one of the clamping motor driving step of fixing the plurality of clamps to the rotary body in such a manner as to be separated from the tube to be cut by the given distance by means of a clamp motor and a plurality of spur gears and the clamp cylinder driving step of fixing the plurality of clamps to the rotary body in such a manner as to be separated from the tube to be cut by the given distance by means of a clamp cylinder.

According to an exemplary embodiment, the cutting step includes: the saw rotating and driving step of rotating the saw in a given direction, while having the same center axis as the rotary body; and the saw blade extending step of moving the plurality of saw blades of the saw toward the inner peripheral wall of the tube.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 is a schematic perspective view showing a tube cutting device for cutting a tube of a waste steam generator according to an exemplary embodiment, wherein the tube cutting device is inserted into the tube of the waste steam generator;

FIG. 2 is a side view showing the tube cutting device according to an exemplary embodiment;

FIG. 3 is a perspective view showing a ball screw disposed on a body of the tube cutting device according to an exemplary embodiment;

FIG. 4 is a perspective view showing a clamp motor mounted on the body of the tube cutting device according to an exemplary embodiment;

FIG. 5 is a perspective view showing a clamp cylinder mounted on the body of the tube cutting device according to an exemplary embodiment;

FIG. 6 is a front view showing a saw and a plurality of saw blades disposed on the end of a rotary body of the tube cutting device according to an exemplary embodiment;

FIG. 7 is a side sectional view showing the saw disposed on the end of the rotary body of the tube cutting device according to an exemplary embodiment;

FIG. 8 is a block diagram showing tube cutting steps of cutting a tube of a waste steam generator according to an exemplary embodiment;

FIG. 9 is a block diagram showing the clamping step in the tube cutting steps for cutting the tube of the waste steam generator according to an exemplary embodiment; and

FIG. 10 is a block diagram showing the cutting step in the tube cutting steps for cutting the tube of the waste steam generator according to an exemplary embodiment.

### DETAILED DESCRIPTION

Hereinafter, the inventive concept is disclosed with reference to the attached drawings wherein the corresponding parts in the exemplary embodiments are indicated by corresponding reference numerals and the repeated explanation on the corresponding parts will be avoided. If it is determined that the detailed explanation on the well known technology related to the disclosure makes the scope of the inventive concept not clear, the explanation will be avoided for the brevity of the description.

In the description, terms, such as the first, the second, A, B, (a) and (b) may be used to describe various elements, but the elements should not be restricted by the terms. The terms are used to only distinguish one element from the other element. Also, when it is said that one element is described as being “connected” or “coupled” to the other element, one element may be directly connected or coupled to the other element, but it should be understood that another element may be present between the two elements.

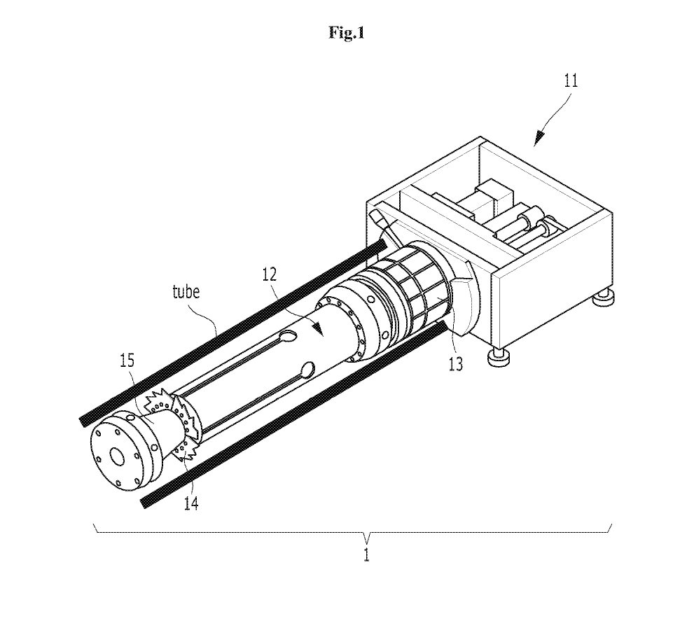

FIG. 1 is a schematic perspective view showing a tube cutting device for cutting a tube of a waste steam generator a waste steam generator according to an exemplary embodiment, wherein the tube cutting device is inserted into a tube of the waste steam generator.

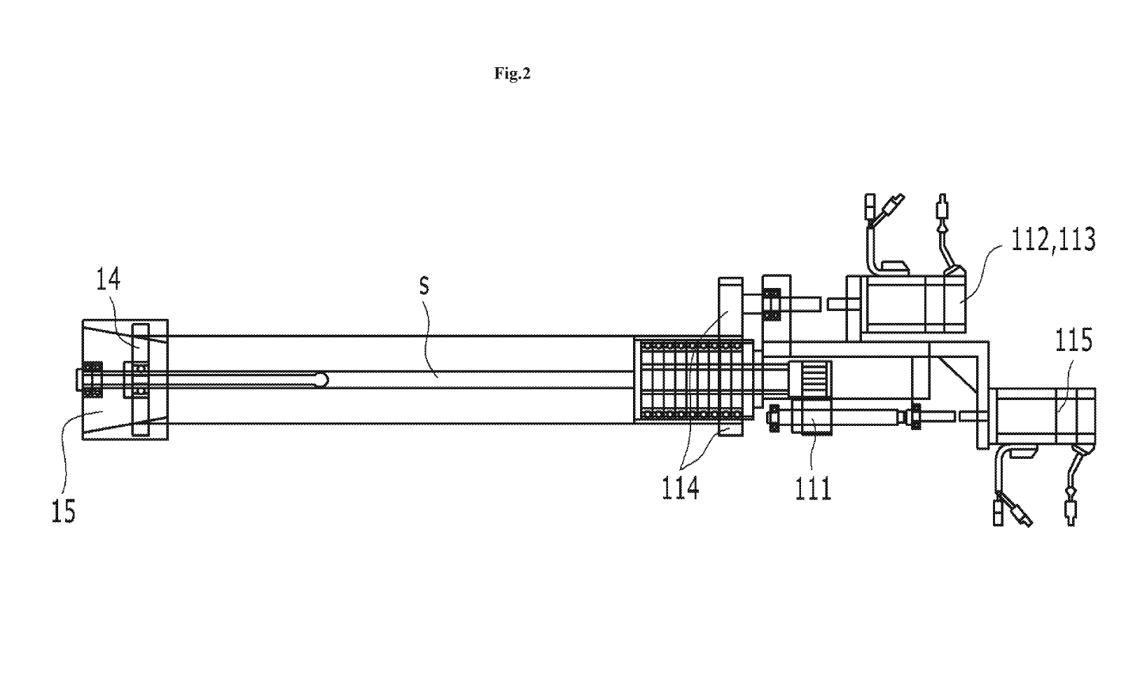

FIG. 2 is a side view showing the tube cutting device for cutting the tube of the waste steam generator according to an exemplary embodiment.

The present disclosure is proposed to solve the above-mentioned problems occurring in the related art, and referring to FIGS. 1 and 2, a tube cutting device 1 for cutting a tube of a waste steam generator according to the present invention is conveyed to a place in which the waste steam generator is installed, is insertedly put into the tube of the waste steam generator, and cuts the tube in the direction of the outside of the tube from the inside of the tube by means of a saw 14.

According to the exemplary embodiment, the tube cutting device 1 includes: a body 11 fixedly located to transmit power therefrom; a tube-shaped rotary body 12 located on one side surface of the body 11 and having a horizontal rotary shaft S in such a manner as to rotate in a given direction; a plurality of clamps 13 located along the outer peripheral surface of the body side end portion of the rotary body 12 to fix the rotary body 12 to the tube to be cut; and the saw 14 located on the opposite end portion to the body side end portion of the rotary body 12 in such a manner as to rotate together with the rotary body 12 to cut the tube.

According to the exemplary embodiment, on the other hand, the tube cutting device 1 includes: the body 11 fixedly located to transmit power therefrom; the tube-shaped rotary body 12 located on one side surface of the body 11 and having a horizontal rotary shaft S in such a manner as to rotate in a given direction; the plurality of clamps 13 located along the outer peripheral surface of the body side end portion of the rotary body 12 to fix the rotary body 12 to the tube to be cut; the saw 14 located on the opposite end portion to the body side end portion of the rotary body 12 in such a manner as to rotate together with the rotary body 12 to cut the tube; and a fitting member 15 located on the opposite side to the body side of the saw 14 in such a manner as to be insertedly put into a hollow portion 141 formed on the center of the saw 14.

Referring to FIG. 1, in more detail, the tube cutting device 1 includes the body 11 fixed to a fixing object, while a cutting operation is being conducted, and the cylindrical rotary body 12 located on one side surface of the body 11 in such a manner as to be extended to a horizontal line.

So as to cut the tube of the waste steam generator, the cylindrical rotary body 12 is inserted into the tube, and accordingly, the diameter of the cylindrical rotary body 12 is desirably not larger than that of the tube.

Further, the fitting member 15 is conical and disposed on the opposite side to the body side of the saw 14, so that a peak portion 151 of the conical fitting member 15 is inserted into the hollow portion 141 formed on the center of the saw 14.

Furthermore, the plurality of clamps 13 is disposed along the outer periphery of the body side end portion of the rotary body 12 with given sizes so as to prevent the rotary body 12 inserted into the tube from being unnecessarily moved and to allow the center axis of the tube to correspond with the center axis of the rotary body 12.

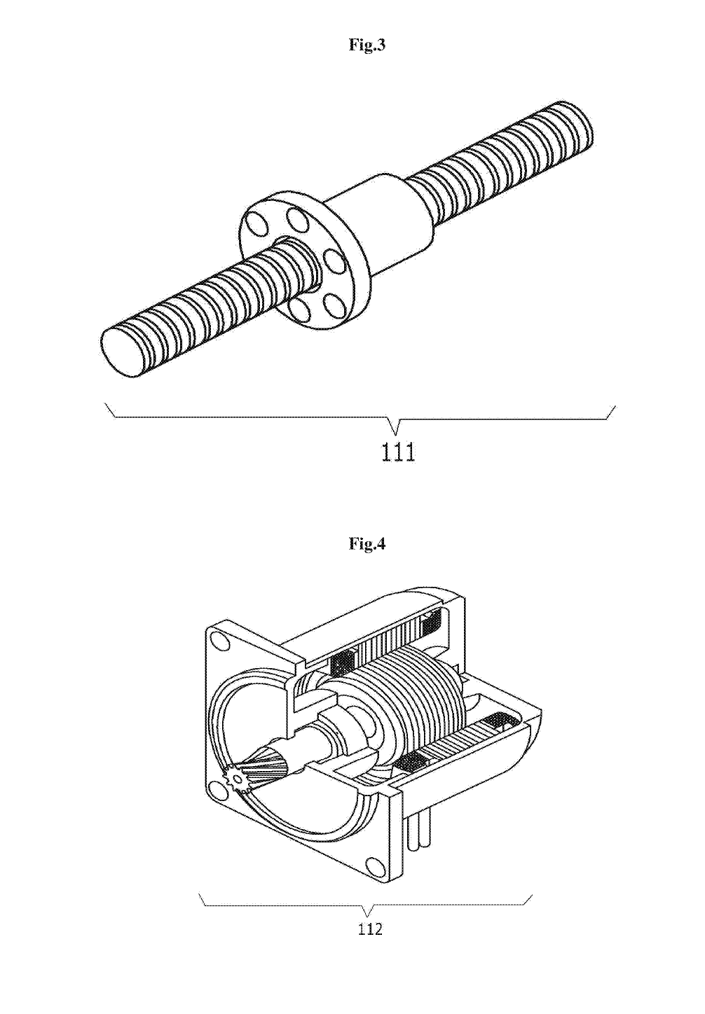

FIG. 4 is a perspective view showing a clamp motor mounted on the body of the tube cutting device according to an exemplary embodiment.

Referring to FIGS. 1, 2 and 4, the plurality of clamps 13 is desirably driven by means of a clamp motor 112 or a clamp cylinder 113 disposed in the body 11.

The cylindrical rotary body 12 is rigidly fixed to the interior of the tube by means of the plurality of clamps 13, and next, the doughnut-shaped saw 14 and the plurality of saw blades 142 disposed on the opposite end portion of the rotary body 12 to the body side thereof are driven by means of a saw blade driving motor 115 disposed in the interior of the body 11.

In the step of cutting the tube through the rotation of the plurality of segmented saw blades 142, further, the fitting member 15 is driven forwardly and backwardly along a horizontal line by means of a ball screw 111 so that the plurality of saw blades 142 can be moved in the direction of the outside of the tube from the inside of the tube.

In the step before the plurality of segmented saw blades 142 rotates, the fitting member 15 is driven forwardly and backwardly on the horizontal line by means of the ball screw 111 so that the fixed position of the plurality of saw blades 142 can correspond with the point at which the tube is cut.

The saw 14 and the plurality of saw blades 142 rotate in a given direction to cut the tube in the direction of the outside of the tube from the inside of the tube.

So as to cut the tube in the direction of the outside of the tube from the inside of the tube in the cutting step, further, the saw 14 and the plurality of saw blades 142 just rotate by means of the saw blade driving motor 115 or a driving motor disposed in the body 11, and in addition, the plurality of saw blades 142 can be extended toward the tube.

FIG. 3 is a perspective view showing the ball screw disposed on the body of the tube cutting device according to an exemplary embodiment.

Referring to FIG. 3, the body 11 has the ball screw 111 adapted to allow the rotary body 12 to be linearly driven on the horizontal axis thereof in the interior of the tube to be cut.

So as to allow the tube to be cut in the direction of the outside of the tube from the inside of the tube in the cutting step, furthermore, the fitting member 15 is driven forwardly and backwardly on a horizontal line by means of the ball screw 111, so that the interval between the neighboring saw blades 142 of the saw 14 becomes increased along the sloping surface of the conical fitting member 15, thereby allowing the diameter of the saw 14 to be large.

Accordingly, the saw 14 and the plurality of saw blades 142 just rotate, and in addition, the plurality of segmented saw blades 142 is extendable toward the tube.

To do this, the body 11 includes the ball screw 111 adapted to allow the fitting member 15 to be driven forwardly and backwardly on the horizontal line toward and from the hollow portion 141 of the saw 14.

FIG. 5 is a perspective view showing a clamp cylinder mounted on the body of the tube cutting device according to an exemplary embodiment.

As shown in FIG. 5, the body 11 desirably includes any one of the clamp motor 112 or the clamp cylinder 113 so as to drive the plurality of clamps 13. In this case, the clamp motor 112 includes a rotor, a stator, a ball bearing and a shaft, and the clamp cylinder 113 includes a hydraulic cylinder.

Further, the body 11 includes a plurality of spur gears 114 engaged with the clamp motor 112 to drive the plurality of clamps 13.

In addition, the saw 14 is entirely formed in a doughnut shape and desirably includes the hollow portion 141 formed on the center thereof and the plurality of saw blades 142 segmented with a given size and shape.

The body 11 includes the saw blade driving motor 115 adapted to move the plurality of segmented saw blades 142 to the inner peripheral wall of the tube.

In more detail, as shown in FIG. 2, the clamp motor 112 or the clamp cylinder 113 is located in the interior of the body 11 to drive the plurality of clamps 13, and the ball screw 111 for driving the saw 14 in forward and backward directions on the horizontal line is disposed on the rear side of the center axis of the rotary body 12.

Further, the body 11 includes the saw blade driving motor 115 adapted to drive the plurality of saw blades 142 in such a manner as to be extended from the inside of the tube toward the outside of the tube.

Furthermore, the tube cutting device 1 includes the fitting member 15 adapted to move the plurality of segmented saw blades 142 to the inner peripheral wall of the tube.

In more detail, as shown in FIG. 2, the clamp motor 112 or the clamp cylinder 113 is located in the interior of the body 11 to drive the plurality of clamps 13.

Further, the body 11 includes the fitting member 15 adapted to extend the plurality of saw blades 142 from the inside of the tube toward the outside of the tube.

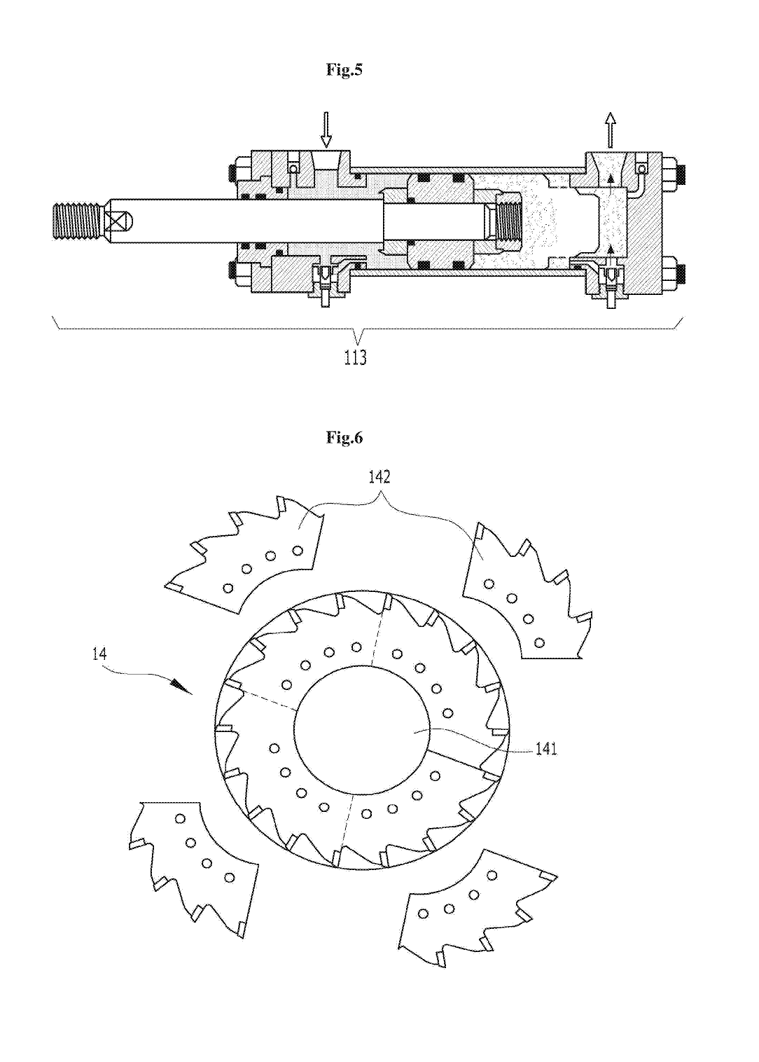

FIG. 6 is a front view showing the saw and the plurality of saw blades disposed on the end of the rotary body of the tube cutting device according to an exemplary embodiment.

Referring to FIG. 6, the saw 14 has the hollow portion 141 formed on the center thereof and the four saw blades 142 segmented with the same size.

The plurality of saw blades 142 is extended in every direction according to the forward and backward driving in the horizontal direction of the fitting member 15, thereby making it possible to cut the tube in the direction of the outside of the tube from the inside of the tube.

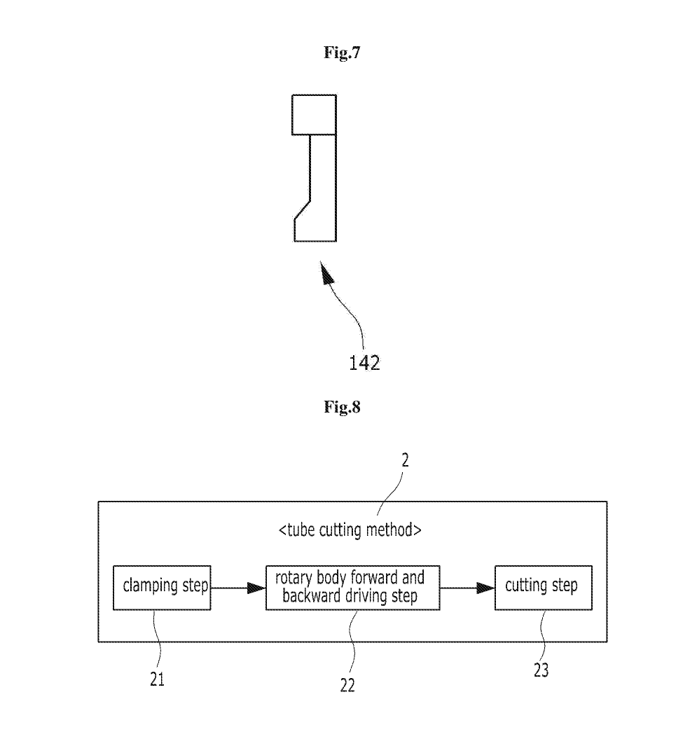

FIG. 7 is a side sectional view showing the saw disposed on the end of the rotary body of the tube cutting device according to an exemplary embodiment.

Referring to FIG. 7 showing the section of each saw blade 142, in more detail, the saw blade 142 includes a blade portion formed on the upper portion thereof and a support portion formed on the underside of the blade portion to fixedly support the blade portion thereagainst.

In this case, the support portion of each saw blade 142 is desirably concaved to a given depth on one side surface thereof so as to avoid the interference and friction with the cut surface of the tube.

In the process of cutting the tube by means of the plurality of saw blades 142, accordingly, the plurality of saw blades 42 can be accessed to the inner peripheral wall of the tube at a given angle through the tapered angle of the fitting member 15 disposed on the end portions thereof.

So as to prevent the plurality of saw blades 142 accessed to the inner peripheral wall of the tube at the given angle from being damaged or broken, one side surface of the support portion of each saw blade 142 is concaved to the given depth.

Further, the tube cutting device 1 is located in a work place having the danger of radioactive substances, and so as to allow a worker to drive the above-mentioned parts of the tube cutting device 1 from a long distance, accordingly, a controller is desirably mounted in the body 1.

The controller is provided wiredly or wirelessly, and desirably, the worker operates the controller at the outside of the work place.

In addition to the tube cutting device 1 according to an exemplary embodiment, a tube cutting method 2 according to the exemplary embodiment is proposed using the same principle as the above.

FIG. 8 is a block diagram showing the tube cutting steps for cutting the tube of the waste steam generator according to an exemplary embodiment.

In more detail, the tube cutting method 2 according to an exemplary embodiment includes the clamping step 21 of fixing the tube-shaped rotary body 12 in such a manner as to be separated from the tube to be cut by a given distance by means of the plurality of clamps 13 disposed along the outer peripheral surface of the body side end portion of the rotary body 12, the rotary body forward/backward driving step 22 of linearly driving the rotary body 12 on the horizontal axis in the interior of the tube to be cut by means of the ball screw 111, and the cutting step 23 of moving the plurality of saw blades 142 of the saw 14 to the inner peripheral wall of the tube to cut the tube.

FIG. 9 is a block diagram showing the clamping step in the tube cutting steps for cutting the tube of the waste steam generator according to an exemplary embodiment.

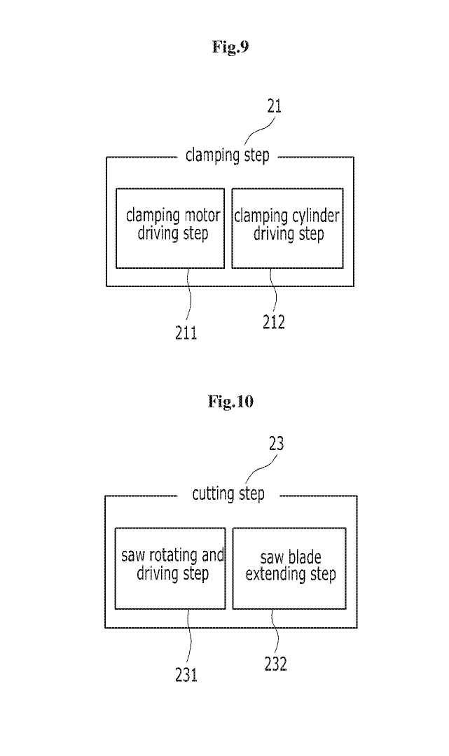

FIG. 10 is a block diagram showing the cutting step in the tube cutting steps for cutting the tube of the waste steam generator according to an exemplary embodiment.

As shown in FIG. 9, the clamping step 21 includes any one of the clamping motor driving step 211 of fixing the plurality of clamps 13 to the rotary body 12 in such a manner as to be separated from the tube to be cut by the given distance by means of the clamp motor 112 and the plurality of spur gears 114 and the clamp cylinder driving step 212 of fixing the plurality of clamps 13 to the rotary body 12 in such a manner as to be separated from the tube to be cut by the given distance by means of the clamp cylinder 113.

As shown in FIG. 10, further, the cutting step 23 includes the saw rotating and driving step 231 of rotating the saw 14 in a given direction, while having the same center axis as the rotary body 12, and the saw blade extending step 232 of moving the plurality of saw blades 142 of the saw 14 toward the inner peripheral wall of the tube.

As described above, the tube cutting device for cutting the tube of the waste steam generator is first conveyed to a place in which the waste steam generator is installed, is insertedly put into the tube of the waste steam generator, and then cuts the tube in the direction of the outside of the tube from the inside of the tube.

Further, the tube cutting device according to the exemplary embodiment is capable of conducting the cutting operation, while the waste steam generator is not being separated from a nuclear power plant, unlike the conventional practice, generating no dust and aerosol as secondary contamination substances therefrom, and safely protecting a worker from radioactive contamination substances not through labor force, but through mechanical work.

The foregoing description of the exemplary embodiments has been presented for the purpose of illustration; it is not intended to be exhaustive or to limit the inventive concept to the precise forms disclosed. Persons skilled in the relevant art can appreciate that many modifications and variations are possible in light of the above teachings. It is therefore intended that the scope of the inventive concept be limited not by this detailed description, but rather by the claims appended hereto.

What is claimed is:

1. A tube cutting device for cutting a tube of a waste steam generator, the tube cutting device comprising:
a body configured to transmit power;
a tube-shaped rotary body provided on a side surface of the body and having a horizontal rotary shaft configured to rotate with the power supplied from the body;
a plurality of clamps provided along an outer peripheral surface of a first end portion of the rotary body and configured to fix the rotary body to the tube to be cut;
a saw provided on a second end portion opposite to the first side end portion of the rotary body and configured to rotate together with the rotary body to cut the tube; and
a fitting member configured to be inserted into a hollow portion formed on a center portion of the saw.

2. The tube cutting device according to claim 1, wherein the body comprises a ball screw configured to linearly drive the rotary body on a horizontal axis of the rotary body.

3. The tube cutting device according to claim 1, wherein the body comprises a ball screw configured to drive the fitting member forwardly and backwardly along a horizontal line toward and from the hollow portion of the saw.

4. The tube cutting device according to claim 1, wherein the fitting member has a conical shape and is disposed on an opposite side to a side of the saw facing the body, and
wherein a portion of the fitting member is configured to be inserted into the hollow portion formed on the center portion of the saw.

5. The tube cutting device according to claim 1, wherein the body comprises a clamp motor configured to drive the plurality of clamps, and
wherein the clamp motor comprises:
a motor rotary body;
a stator;
a ball bearing; and
a motor shaft.

6. The tube cutting device according to claim 1, wherein the body comprises a clamp cylinder configured to drive the plurality of clamps, and
wherein the clamp cylinder includes a hydraulic cylinder.

7. The tube cutting device according to claim 5, wherein the body further comprises a plurality of spur gears engaged with the clamp motor and configured to drive the plurality of clamps.

8. The tube cutting device according to claim 1, wherein the saw is formed in a doughnut shape and comprises:
the hollow portion formed on the center portion thereof; and
a plurality of saw blades forming the saw.

9. The tube cutting device according to claim 8, wherein the body comprises a saw blade driving motor configured to move the plurality of saw blades toward an inner peripheral wall of the tube.

10. The tube cutting device according to claim 1, further comprising a controller configured to wiredly or wirelessly control the driving of the rotary body, the plurality of clamps and the saw.

11. The tube cutting device according to claim 2, wherein the fitting member has a conical shape and is disposed on an opposite side to a side of the saw facing the body, and
wherein a portion of the fitting member is configured to be inserted into the hollow portion formed on the center portion of the saw.

12. The tube cutting device according to claim 3, wherein the fitting member has a conical shape and is disposed on an opposite side to a side of the saw facing the body, and
wherein a portion of the fitting member is configured to be inserted into the hollow portion formed on the center portion of the saw.

13. The tube cutting device according to claim 2, wherein the body comprises a clamp motor configured to drive the plurality of clamps, and
wherein the clamp motor comprises:
a motor rotary body;
a stator;
a ball bearing; and
a motor shaft.

14. The tube cutting device according to claim 2, wherein the body comprises a clamp cylinder configured to drive the plurality of clamps, and
wherein the clamp cylinder includes a hydraulic cylinder.
